(19) United States
(12) Patent Application Publication
(10) Pub. No.: US 2008/0025753 A1
(43) Pub. Date: Jan. 31, 2008

(54) Roll, replacement unit, and image forming apparatus

(75) Inventors: Mitsuo Yamamoto, Ebina-shi (JP); Yasutomo Ishi, Ebina-shi (JP); Masanori Kobayashi, Ebina-shi (JP); Masayuki Kono, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/783,493

(22) Filed: Apr. 10, 2007

(30) Foreign Application Priority Data
Jul. 31, 2006 (JP) 2006-208898

(51) Int. Cl. G03G 15/02

(52) U.S. Cl. 399/100; 399/176

(57) ABSTRACT

A roll includes a shaft, and a foamed material coating the shaft that includes a first section that extends from the shaft to a surface of the foamed material and has electrical resistance, a value of which is within a first range, and a second section that extends from the shaft to the surface of the foamed material and has electrical resistance, a value of which is within a second range different from the first range.

This application is based on and claims priority under 35 USC 119 from Japanese Patent Application No. 2006-208898 filed on Jul. 31, 2006.

### BACKGROUND

### Technical Field

The present invention relates to a roll, a replacement unit, and an image forming apparatus.

### SUMMARY

An aspect of the present invention provides a roll including a shaft, and a foamed material coating the shaft that includes a first section that extends from the shaft to the surface of the foamed material and has electrical resistance, a value of which is within a first range, and a second section that extends from the shaft to the surface of the foamed material and has electrical resistance, a value of which is within a second range different from the first range.

### BRIEF DESCRIPTION OF THE DRAWINGS

Exemplary embodiments of the present invention will be described in detail with reference to the following figures, wherein:

FIG. 1 is a schematic diagram illustrating a configuration of an image forming apparatus according to an exemplary embodiment;

FIGS. 2A and 2B are diagrams illustrating developer D;

FIG. 3 is a side view of photosensitive drum 11 and charging unit 12;

FIG. 4 is a front view of photosensitive drum 11 and charging unit 12;

FIG. 5 is a diagram illustrating a current pathway from power supply 90 to ammeter 91;

FIG. 6 is a diagram illustrating an example of temporal change of a current value measured by ammeter 91;

FIG. 7 is a diagram illustrating a configuration of cleaning roll 82 according to another exemplary embodiment;

FIG. 8 is a diagram illustrating a configuration of cleaning roll 82 according to another exemplary embodiment;

FIG. 9 is a diagram illustrating a configuration of cleaning roll 82 according to another exemplary embodiment;

FIG. 10 is a diagram illustrating a configuration of cleaning roll 82 according to another exemplary embodiment; and

FIG. 11 is a diagram illustrating a configuration of cleaning roll 82 according to another exemplary embodiment.

### DETAILED DESCRIPTION

### Exemplary Embodiment

An exemplary embodiment of the present invention will be described.

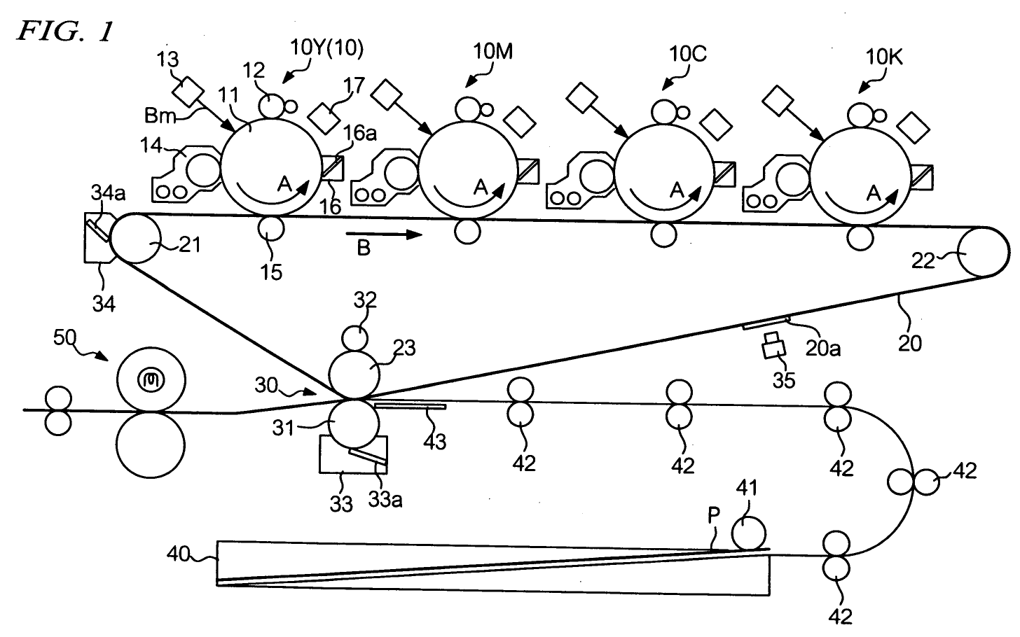

FIG. 1 illustrates an image forming apparatus according to the present exemplary embodiment, which is a tandem type or an intermediate transfer type. The image forming apparatus includes: plural image forming units 10 (specifically, image forming units 10Y, 10M, 10C, and 10K); intermediate transfer belt 20; second transfer unit 30; and fixing unit 50. Image forming units 10, respectively, form toner images of the plural colors in an electrophotographic method. Toner images formed by image forming units 10 are transferred to intermediate transfer belt 20 (first transfer), and held by intermediate transfer belt 20. Toner images transferred to intermediate belt 20 are further transferred to recording material P (second transfer) by second transfer unit 30. Toner images transferred to recording material P are fixed by fixing unit 50.

In the present exemplary embodiment, each of image forming units 10 includes: photosensitive drum 11; charging unit 12; and laser exposure unit 13. Photosensitive drum 11 is a charged body or an image carrier which rotates in the direction of arrow A. Charging unit 12 charges photosensitive drum 11. Laser exposure unit 13 forms an electrostatic latent image on photosensitive drum 11. An exposure beam irradiated by laser exposure unit 13 is depicted as arrow Bm in FIG. 1.

Each of image forming units 10 also includes development unit 14 and first transfer roll 15. Development unit 14 houses toner of each color which visualizes an electrostatic latent image formed on photosensitive drum 11. First transfer roll 15 transfers a toner image of each color formed on photosensitive drum 11 to intermediate transfer belt 20.

Each of mage forming units 10 further includes drum cleaner 16 and static eliminator 17. Drum cleaner 16 removes residual toner from photosensitive drum 11. Static eliminator 17 discharges the surface of photosensitive drum 11 after the drum has passed drum cleaner 16.

Photosensitive drum 11 has a surface of an organic photosensitive layer. Charging unit 12 charges photosensitive drum 11 at a certain potential (e.g. minus 500 V). More information on photosensitive drum 11 and charging unit 12 will be described later.

Laser exposure unit 13 exposes, on the basis of image signals, the surface of photosensitive drum 11 charged by charging unit 12, to lower the potential of the surface to e.g. minus 50 V, and thereby forms an electrostatic latent image.

Development unit 14 houses a two-component developer containing: toner of yellow, magenta, cyan, or black; and a carrier which is a magnetic material coated with a semi-conductive material. Toner and carrier are stirred and rubbed together by development unit 14 to make the toner negatively charged, and carried on a development sleeve. Toner is transferred by a developing bias applied to the development sleeve to an exposed area of the surface of photosensitive drum 11 (reversal development).

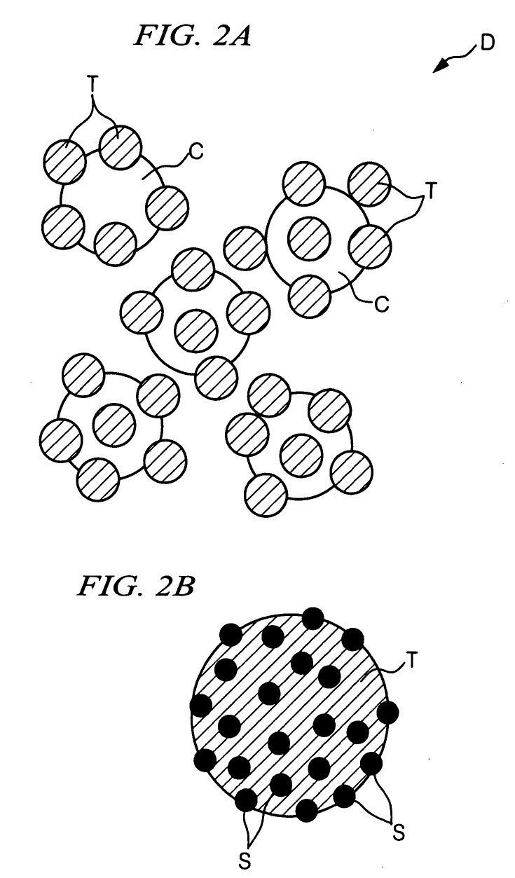

Now, developer D used in reversal development will be described in detail with reference to FIG. 2.

Developer D includes magnetic carriers C and toner particulates T colored with yellow, magenta, cyan, or black, as shown in FIG. 2A. Toner particulates T have additives S, as shown in FIG. 2B.

Carriers C of developer D may be ferrite beads which have a particle diameter of approximately 35 μm on an average. Additive S of developer D may be inorganic particulates which have a particle diameter of 5 to 200 nm on an average, such as silica (SiO₂), titania (TiO₂), and ceria (CeO₂). Toner particulates T have a tendency to charge negatively, and are produced from a binder resin such as polyester or styrene-acrylate, a colorant, and wax, using suspension polymerization, emulsion aggregation, dissolution suspension, and so on. The particle diameter (mean volume diameter) of toner particulate T is approximately 6.4 μm according to a measurement using coulter counter produced by Beckman Coulter, Inc. However, the mean volume diameter of toner particulate T may be 3 to 10 μm in order to form a high-quality image. The shape of toner particulate T (sphericity) is represented by a shape factor, and is expressed in the following formula. To obtain an absolute maximum length and a projected area of toner particulate T in the formula, an optical microscope (Micro Photo FXA produced by Nikon) for obtaining a closeup picture of toner particulate T and an image analyzer (Luzex 3 produced by Nireco) for analyzing the closeup picture are used.

Shape Factor (ML²/A)=(Absolute Maximum Length of Toner Particulate T)²/Projected Area of Toner Particulate T·π/4·100

In the formula, a shape factor is expressed as a ratio of a projected area of toner particulate T and an area of a circle circumscribing the projected area. If toner particulate T is a perfect sphere, the value of a shape factor is 100. As the sphericity of toner particulate T decreases, the value of a shape factor becomes greater. Since the amount of residual toner decreases as the value of a shape factor decreases, it is preferable that the value of a shape factor is approximately 100 to 140. In the present exemplary embodiment, the value of a shape factor of toner particulate T is 134.

Additive S includes silica, titania, and celia. Additive S added to toner T includes silica of 1.48 percent by weight, titania of 0.8 percent by weight, and celia of 0.7 percent by weight. The average particle diameter of silica is 100 nm, and the value of a shape factor is less than or equal to 140, namely the shape is substantially spherical.

Returning to FIG. 1, first transfer roll 15 is made from urethane foam rubber, and the resistance value thereof is 10⁶ to 10⁸Ω.

Drum cleaner 16 has drum cleaning blade 16a which projects against the direction of rotation of photosensitive drum 11 (doctor direction), as shown by arrow A.

Intermediate transfer belt 20 is suspended by plural rolls of drive roll 21, tension roll 22, and back up roll 23, and rotates in the direction of arrow B. Drive roll 21 drives intermediate transfer belt 20. Tension roll 22 adjusts the tension of intermediate transfer belt 20. Back up roll 23 functions as a part of second transfer unit 30 as described later.

Intermediate transfer belt 20 is a single layer belt of polyimide or polyamide, and the thickness thereof is approximately 0.1 mm. If a first transfer bias having a polarity (in the present exemplary embodiment, positive) opposite to the polarity of toner is applied to first transfer roll 15, each toner image on photosensitive drums 11 is attracted by the first transfer bias to intermediate transfer belt 20, and consequently a layered toner image is formed on immediate transfer belt 20.

Second transfer unit 30 includes second transfer roll 31 and back up roll 23. Second transfer roll 31 is arranged so that it comes into contact with intermediate transfer belt 20. Back up roll 23 is an electrode couple of second transfer roll 31, and arranged in the back side of intermediate transfer belt 20. There next to back up roll 23 is metallic charging roll 32 for applying a second transfer bias to back up roll 23.

Second transfer roll 31 is a conductive roll, and its volume resistivity may be lowly resistive, specifically less than or equal to 10⁷ Ωcm, to keep its surface potential equal to ground potential. Second transfer roll 31 has roll cleaning blade 33a below it. Roll cleaning blade 33a is made from polyurethane, and used for removing toner from second transfer roll 31 during a second transfer.

Back up roll 23 is an insulating roll coated with a semi-conductive thin-layer film. The thickness of the thin-layer film is 10 to 200 μm, and the surface resistivity is 10⁷ to 10¹¹Ω per unit area.

In the downstream, as compared to second transfer roll 31, of intermediate transfer belt 20, there is provided a belt cleaner 34 for cleaning the surface of intermediate transfer belt 20 after a second transfer.

Belt cleaner 34 has belt cleaning blade 34a which projects against the direction of rotation of intermediate transfer belt 20 (doctor direction), as shown by arrow B.

In the upstream, as compared to second transfer roll 31, of intermediate transfer belt 20, there is provided reference sensor (home position sensor) 35 which generates a signal for determining a timing of image formation by each image forming unit 10 (10Y, 10M, 10C, and 10K). Reference sensor 35 detects predetermined mark 20a provided on a non-image area of intermediate transfer belt 20, and generates a signal. A controller (not shown) receiving the signal instructs each image forming unit 10 to start image formation.

In a paper transfer system, when paper P is fed by feed roll 41 at a predetermined timing, paper P is carried by carrier roll 42 and carrier chute 43 to a second transfer position where intermediate transfer belt 20 and second transfer roll 31 come into contact with each other. Paper P which has passed through a second transfer is carried to fixing unit 50.

Now, an image forming process of an image forming apparatus according to the present exemplary embodiment will be described.

If the image forming apparatus is configured as a digital color copying machine, when a start button (not shown) of the image forming apparatus is pushed by a user, a document set on a platen glass (not shown) of the image forming apparatus is read by a color image reader (not shown). The read image is converted to digital image signals, which represent the image in four colors (Y, M, C, and K), by an image signal processing. The digital image signals are temporarily stored in a memory, and on the basis of which, a toner image of each color is formed by image forming units 10 (10Y, 10M, 10C, and 10K).

In each of image forming units 10 (10Y, 10M, 10C, and 10K), photosensitive drum 11 is charged by charging unit 12, and an electrostatic latent image is formed on photosensitive drum 11 by laser exposure unit 13 according to the digital image signals. The formed electrostatic latent image is developed by developing unit 14, and thereby a toner image of each color is formed.

It is to be noted that if the image forming apparatus is configured as a color printer, a toner image of each color may be formed on the basis of external image signals.

The toner image formed on photosensitive drum 11 is transferred to intermediate transfer belt 20 (first transfer) by a first transfer bias applied to first transfer roll 15 on a first transfer position where photosensitive drum 11 and intermediate transfer belt 20 come into contact with each other. After the first transfer, photosensitive drum 11 gets rid of residual toner by drum cleaner 16, and is discharged by static eliminator 17.

A toner image transferred to intermediate transfer belt 20 from each photosensitive drum 11 of image forming units 10 forms a layered toner image, and the layered toner image is carried to a second transfer position by intermediate transfer belt 20.

Meanwhile, paper P is fed by feed roll 41 at a predetermined timing and carried to second transfer unit 30. When paper P is inserted between back up roll 23 and second transfer roll 31 together with intermediate transfer belt 20, a layered toner image formed on intermediate transfer belt 20 is transferred to paper P (second transfer) by a second transfer electric field produced between back up roll 23 and second transfer roll 31. After that, paper P is carried to fixing unit 50, and the transferred layered toner image on paper P is fixed by fixing unit 50. Meanwhile, intermediate transfer belt 20 gets rid of residual toner by belt cleaner 34 after the second transfer.

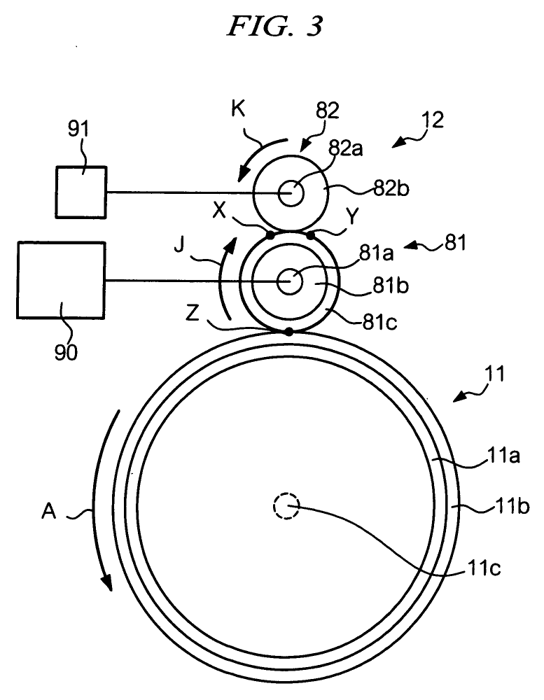

Now, details of photosensitive drum 11 and charging unit 12 will be described with reference to FIG. 3.

Photosensitive drum 11 includes: hollow aluminum drum 11a of approximately 47 mm in diameter; organic photosensitive layer 11b covering the outer circumferential surface of aluminum drum 11a; and shaft 11c. Photosensitive drum 11 rotates on a motor (not shown) connected to shaft 11c.

Charging unit 12 includes charging roll 81 and cleaning roll 82. Charging roll 81 is arranged so that it comes into contact with photosensitive drum 11, and charges photosensitive drum 11. Cleaning roll 82 is arranged so that it comes into contact with charging roll 81, and cleans charging roll 81.

Charging roll 81 includes: stainless rotating shaft 81a; epichlorohydrin rubber layer 81b covering the outer circumferential surface of rotating shaft 81a; and nylon resin layer 81c covering the outer circumferential surface of epichlorohydrin rubber layer 81b. The diameter of rotating is 8 mm, the thickness of epichlorohydrin rubber layer 81b is 3 mm, and the thickness of nylon resin layer 81c is 5 μm.

Charging roll 81 is rotatably suspended at both ends of rotating shaft 81a held by shaft bearings (not shown), and caused to rotate in the direction of arrow J by photosensitive drum 11 rotating in the direction to arrow A. One end of rotating shaft 81a is connected to power supply 90. When power supply 90 applies charging bias, which is an AC voltage (equal to or greater than 1500 V, peak-to-peak value) superimposed on a DC voltage (minus 500 V), to charging roll 81, charging roll 81 charges the outer circumferential surface of photosensitive drum 11 at a certain potential (e.g. minus 500 V).

Cleaning roll 82 is stainless rotating shaft 82a which has an outer circumferential surface of foamed polyurethane layer 82b which is a poroelastic layer. The diameter of rotating shaft 82a is 6 mm, and the thickness of foamed polyurethane layer 82b is 2.5 mm.

Cleaning roll 82 is suspended at both ends held by shaft bearings (not shown), rotatably and so that cleaning roll 82 and charging roll 81 are arranged so their axes are parallel and come into contacts with each other. Cleaning roll 82 is caused to rotate in the direction of arrow K by charging roll 81 rotating in the direction of arrow J. A torque needed for rotating cleaning roll 82 is reduced, if the diameter of cleaning roll 82 is shorter than that of charging roll 81 as in a case where the former is 11 mm and the latter is 14 mm. One end of rotating shaft 82a of cleaning roll 82 is connected to ammeter 91 for measuring current flowing rotating shaft 82a.

Cleaning roll 82 is provided as a cleaner of charging roll 81 to prevent poor charging of charging roll 81. A more detailed description will be given below.

In each development unit 14 of image forming units 10, developer D of a certain color is agitated and carried by a paddle (not shown). In the meantime, carriers C and toner particulates T are rubbed against each other and consequently, toner particulates T are negatively charged. Subsequently, developer D is transferred onto a development roll (not shown), and conveyed, by rotation of the developing roll, to a position where the developing roll faces photosensitive drum 11. At the position, developer D forms a magnetic brush toward photosensitive drum 11, which develops an electrostatic latent image formed on photosensitive drum 11. When the electrostatic latent image is developed, while most toner particulates T and additives S are transferred onto photosensitive drum 11, some toner particulates T and additives S, and carriers C remain on the development roll.

Toner particulates T and additives S transferred onto photosensitive drum 11 are conveyed, by rotation of photosensitive drum 11, to a first transfer position where photosensitive drum 11 and intermediate transfer belt 20 come into contact with each other. At the first transfer position, when toner particulates T and additives S attached to photosensitive drum 11 are transferred onto intermediate transfer belt 20 (first transfer), some toner particulates T and additives S remain on photosensitive drum 11. The residual toner particulates T and additives S are conveyed, by rotation of photosensitive drum 11, to a position where photosensitive drum 11 faces drum cleaning blade 16a of drum cleaner 16. At the position, while toner particulates T remaining on photosensitive drum 11 are removed by drum cleaner 16, as described above, additives S attached to photosensitive drum 11 pass through drum cleaner 16 and reach a position where photosensitive drum 11 faces charging roll 81, since the particle diameter of additives S is small. At this position, if additives S attach to the outer circumferential surface of charging roll 81, it causes poor charging of charging roll 81. For this reason, cleaning roll 82 is provided as a cleaner of charging roll 81. Cleaning roll 81 removes additives S attached to charging roll 81 while rotating along with charging roll 81.

According to the results of experiments by the inventors, it has been shown that more than 90 percent of additives S transferred onto charging roll 81 are silica. Also, it has been shown that cleaning roll 82 has a longer life span than charging roll 81 which is the subject of cleaning. For these reasons, the degree of contamination of charging roll 81 is monitored, and a replacement period of charging roll 81 is notified, as described later in detail.

Returning to an explanation of cleaning roll 82, foamed polyurethane layer 82b of cleaning roll 82 is divided into a first section and a second section which contact rotating shaft 82a and have electrical resistance different from each other.

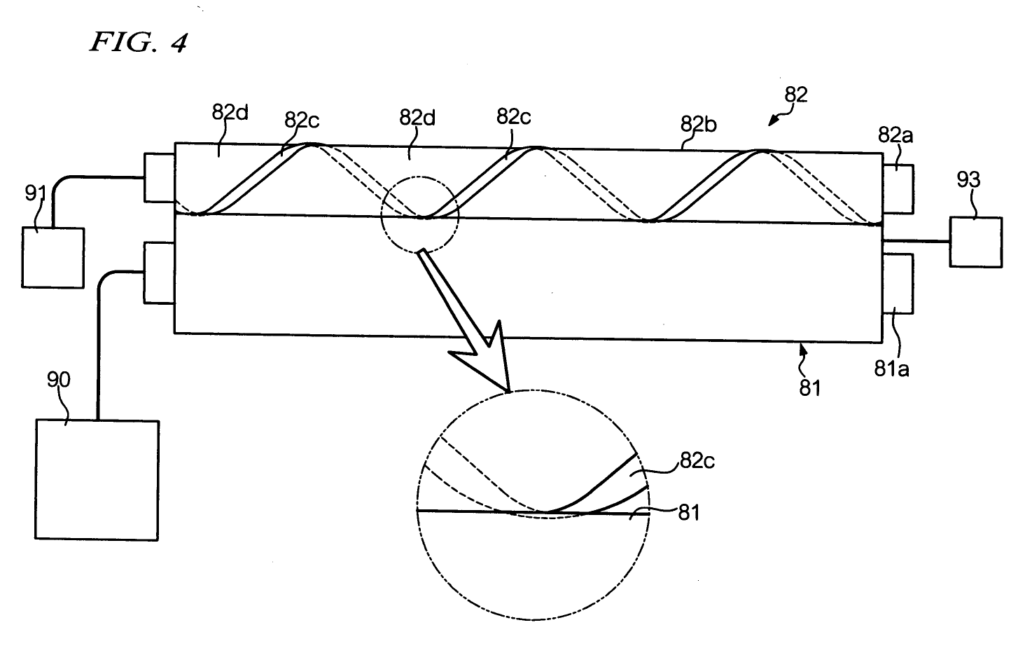

FIG. 4 illustrates charging roll 81 and cleaning roll 82 as seen from a direction perpendicular to their rotating shafts. As shown in the drawing, foamed polyurethane layer 82b includes first section 82c which runs spirally from end to end of foamed polyurethane layer 82b. First section 82c is impregnated with carbon solution and therefore has electrical resistance (below 10⁶Ω) enough to conduct electricity. Foamed polyurethane layer 82b has also second section 82d which is the other section of foamed polyurethane layer 82b. Since second section 82d is not impregnated with carbon solution and has electrical resistance of 10¹¹Ω, it does not conduct electricity. Accordingly, if a current is provided from power supply 90 to rotating shaft 81a of charging roll 81, the current flows from rotating shaft 81a to ammeter 91 through epichlorohydrin rubber layer 81b, nylon resin layer 81c, and first section 82c contacting nylon resin layer 81c (see the part circled by a two-dot chain line of FIG. 4).

Foamed polyurethane layer 82b is impregnated with carbon solution in a spray coating method. Specifically, at first, a conductive latex solution is prepared as carbon solution from: acrylic latex, which is called “AE336” and produced by JSR Corporation, of 100 pts.wt.; carbon black dispersion containing approximately 38 percent nonvolatile matter of 50 pts.wt.; polyethylene glycol having the molecular weight of 2,000, which is produced by Sanyo Kasei Company, of 5 pts.tw. as water-soluble polymer; and pure water of 50 pts.tw. The weight ratio of solid latex and solid water-soluble polymer contained in the conductive latex solution is nine to one. Second, the prepared conductive latex solution is applied to the surface of foamed polyurethane layer 82b out of a spray nozzle so that the coating quantity is 1.8 g. When the conductive latex solution is applied, if the spray nozzle is moved along rotating shaft 82a, and cleaning roll 82 is rotated at a constant speed, the conductive latex solution is spirally applied to foamed polyurethane layer 82b. The applied conductive latex solution penetrates foamed polyurethane layer 82b to the contact point between the layer and rotating shaft 82a. As a result, first section 82c which is electrically conductive is formed. It is to be noted that first section 82c may be formed in not only an area of foamed polyurethane layer 82b corresponding to an area of charging roll 81 where a toner image is developed by development 14, but also outside of the area.

Now, an operation of monitoring contamination of charging roll 81, which is a distinctive feature of the present exemplary embodiment, will be described. The operation is carried out by a controller (not shown) of an image forming apparatus while charging roll 81 rotates along with cleaning roll 82. A controller of an image forming apparatus receives a signal representing a current value measured by ammeter 91, and determines whether the current value is below a predetermined threshold value. If the current value is below the predetermined threshold value, the controller identifies an area of the surface of charging roll 81 which contacted first section 82c of cleaning roll 82 at the time of the measurement, as a contaminated area.

In the process, the reason why it is determined on the basis of the value of a current measured by ammeter 91, that the surface of charging roll 81 is contaminated, will be described.

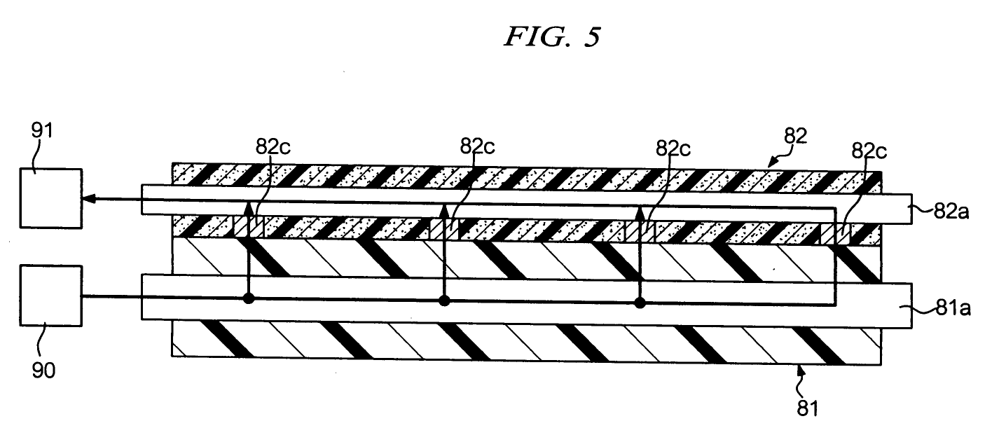

Firstly, as described above, if a current is provided by power supply 90 to rotating shaft 81a of charging roll 81, the current flows from rotating shaft 81a to ammeter 91 through epichlorohydrin rubber layer 81b, nylon resin layer 81c, first section 82c of cleaning roll 82 contacting nylon resin layer 81c, and rotating shaft 82a, as shown in FIG. 5. Accordingly, the value of a current measured by ammeter 91 may be expressed as the value of a voltage of power supply 90 divided by the value of a combined electrical resistance of epichlorohydrin rubber layer 81b, nylon resin layer 81c, and first section 82c of cleaning roll 82 contacting nylon resin layer 81c.

Second, the value of electrical resistance of epichlorohydrin rubber layer 81b and nylon resin layer 81c of charging roll 81 increases, as the layers are contaminated. In contrast, the value of electrical resistance of foamed polyurethane layer 82b changes little, because foamed polyurethane layer 82b agglomerates and drops additives S removed from the surface of charging roll 81, without keeping them.

Accordingly, if the value, of a current measured when an area of the surface of charging roll 81 and first section 82c of cleaning roll 82 come into contact with each other, decreases, it means that the value of electrical resistance of epichlorohydrin rubber layer 81b and nylon resin layer 81c of charging roll 81 increases, namely that a contamination level of the area rises.

In the above process, a contaminated area of the surface of charging roll 81 may be determined using an optical pattern (not shown) provided at the right side of charging roll 81 and rotary encoder 93. An optical pattern has plural slits formed radially from the axis of charging roll 81. Rotary encoder 93 includes: a light source for radiating light to a reference position of an optical pattern; a photosensor for receiving reflected light; and an arithmetic circuit for determining a rotation angle of charging roll 81 on the basis of a cycle of interruptions in receipt of light by a photosensor. A controller of an image forming apparatus receiving a signal from rotary encoder 93 representing a rotation angle of charging roll 81 stores the rotation angle and the receipt time in a memory, and if determining a current value measured by ammeter 91 is below a predetermined threshold value, the controller determines a rotation angle, namely a contaminated area, of charging roll 81 on the basis of a signal from rotary encoder 93 received at the same time as the signal from ammeter 91.

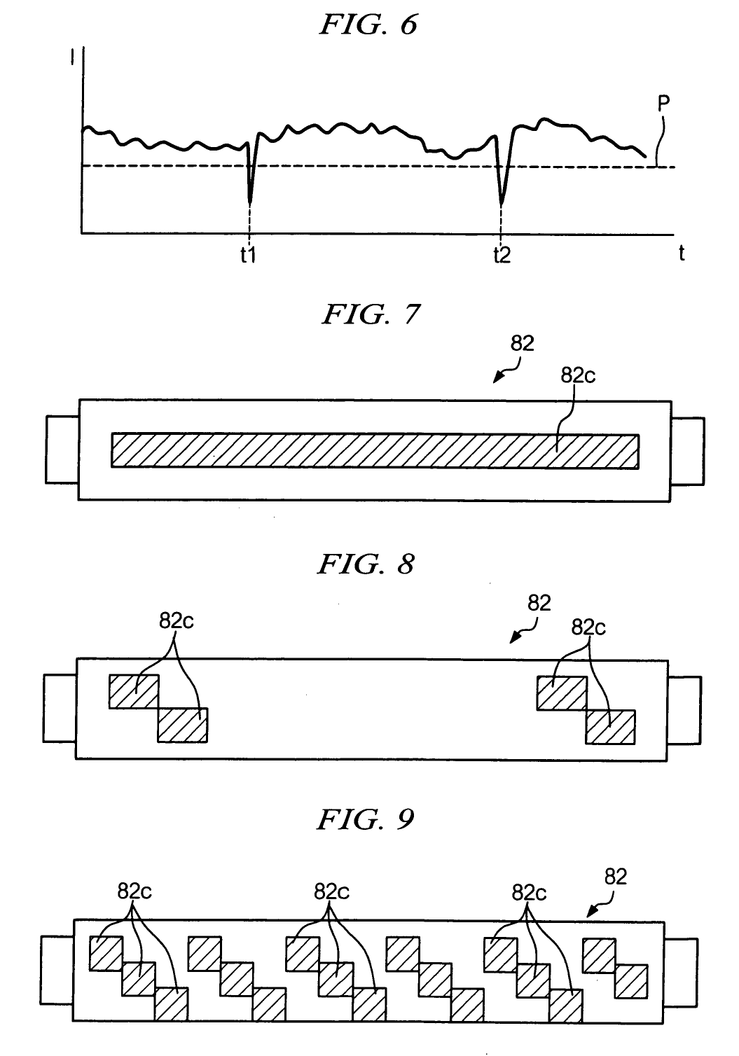

FIG. 6 is a diagram illustrating an example of temporal change of a current value measured by ammeter 91 during a charging roll contamination monitoring process. In the drawing, the vertical axis is current value I, the horizontal axis is time T, and the chained line is a threshold value.

A current value plotted on the drawing is a value of a current flowing from charging roll 81 to cleaning roll 82 through an area of the surface of charging roll 81 contacting first section 82c. Since first section 82c is, as described above, spirally formed, an area of charging roll 81 contacting section 82c moves axially, as time t passes.

According to a charging roll contamination monitoring process described above, areas of charging roll 81 which have contacted first section 82c of cleaning roll 82 at times t1 and t2, when a current value is below a threshold value, are determined as contaminated areas.

It is to be noted that according to results of experiments by the inventors, it has been shown that if a resistance value determined based on a current value is less than or equal to 10¹⁰Ω, a problem in image quality is not caused, but if a resistance value is above 10¹¹Ω, a problem in image quality is caused.

### Other Exemplary Embodiments

In the above exemplary embodiment, where first section 82c of foamed polyurethane layer 82b of cleaning roll 82 is formed from end to end of foamed polyurethane layer 82b spirally, first section 82c may take other forms. FIGS. 7 to 10 are diagrams illustrating different variations of first section 82c in shape.

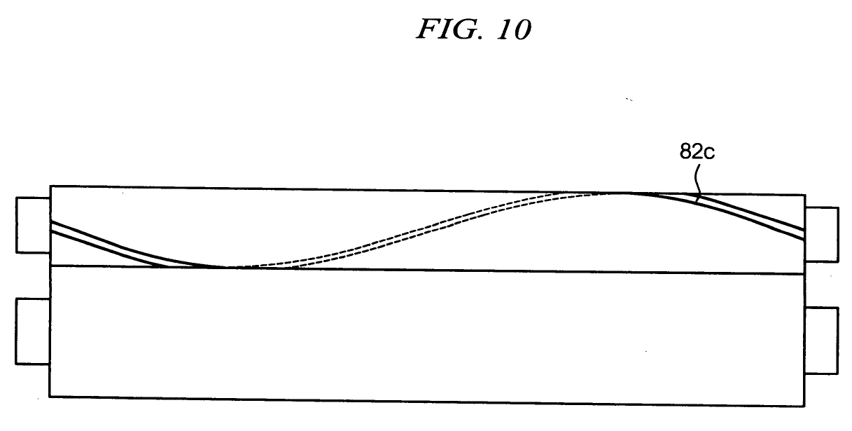

In an example of FIG. 7, first section 82c is formed as a rectangular parallelepiped which has a predetermined depth and is parallel to rotating shaft 82a. In an example of FIG. 8, first section 82c is formed as two pairs of rectangular parallelepipeds which are arranged so that diagonals of each pair form a straight line, and at a predetermined distance from an end of foamed polyurethane layer 82b. In an example of FIG. 9, first section 82c is formed as plural rectangular parallelepipeds arranged so that they form a spiral. In an example of FIG. 10, first section 82c is formed as a long rectangular parallelepiped spirally wounded around rotating shaft 82a one time.

In the above exemplary embodiment, where first section 82c having electrical resistance enough to conduct electricity is formed by impregnating first section 82c with carbon solution, such first section 82c may be formed by a strip of sponge impregnated with carbon which is wound around rotating shaft 82a in a spiral configuration together with a strip of foamed polyurethane. Alternatively, such first section 82c may be formed by a strip of sponge impregnated with carbon which is attached to an area of rotating shaft 82a with conductive resin where foamed polyurethane is not attached to rotating shaft 82c.

In a charging roll contamination monitoring process of the above exemplary embodiment, not only whether charging roll 81 is contaminated but also a contaminated area is determined. Instead, modification may be made so that only whether charging roll 81 is contaminated is determined. It is because even if a contaminated area is only a small part of charging roll 81, if the contamination is severe, charging roll 81 needs to be changed.

In the above exemplary embodiment, where rotating shaft 82a of cleaning roll 82 is connected to ammeter 91, and a contaminated area is determined on the basis of a comparison between a current value measured by ammeter 91 and a threshold value, rotating shaft 82a may be connected to a voltmeter instead of ammeter 91, and a contaminated area may be determined on the basis of a comparison between a voltage value measured by the voltmeter and a threshold value.

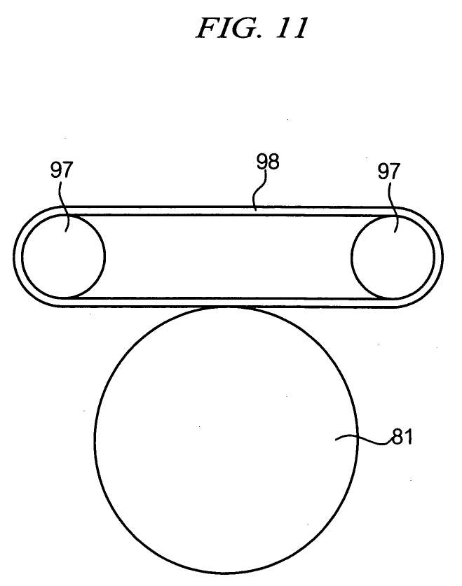

In the above exemplary embodiment, where cleaning roll 82 which is a single roll is used as a member for cleaning charging roll 81, endless belt 98 suspended by a pair of rolls 97 may be used as a member for cleaning charging roll 81 as shown in FIG. 11. Belt 98 may be of the same nature of formed polyurethane layer 82b.

In the above exemplary embodiment, where only cleaning roll 82 is a replaceable unit of an image forming apparatus, a set of cleaning roll 82 and charging roll 81 may be a single replaceable unit.

In the above exemplary embodiment, where cleaning roll 82 and charging roll 81 are caused to rotate by rotation of photosensitive drum 1, they may rotate on their own driving source. The above-mentioned belt 98 also may rotate on its own driving source.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A roll comprising:
a shaft;
a first section that is a foamed material formed on a surface of the shaft, and that has electrical resistance, a value of which is within a first range; and
a second section that is a foamed material formed on a surface of the shaft, and that has electrical resistance, a value of which is within a second range different from the first range.

2. The roll according to claim 1, wherein the first section is formed substantially parallel to the shaft.

3. The roll according to claim 1, wherein the first section is formed as a pair of sections, each of which is arranged at a predetermined distance from an end of the foamed material.

4. The roll according to claim 1, wherein the first section is formed as a plurality of sections arranged so that the sections form a spiral.

5. The roll according to claim 1 that is configured to clean an object to which a predetermined voltage is applied.

6. A replacement unit comprising the roll according to claim 1.

7. An image forming apparatus comprising:
the roll according to claim 5;
an object to be cleaned;
a bearing unit that bears a shaft of the roll rotatably so that a surface of a foamed material coating the shaft and an outer circumferential surface of the object come into contact with each other substantially parallel to the shaft;
a meter that measures a value of a current flowing from the first section into the shaft of the roll; and
determination unit that determines whether the object is contaminated based on the value of a current measured by the meter.

8. The image forming apparatus according to claim 5, wherein the object is a charging roll for charging an image holder for holding an image.

9. A roll comprising:
a shaft;
a first section that is a foamed material spirally formed on a surface of the shaft, and that has electrical resistance, a value of which is within a first range; and
a second section that is a foamed material formed on a surface of the shaft, and that has electrical resistance, a value of which is within a second range different from the first range.

10. (canceled)
